(19) United States
(12) Patent Application Publication
(10) Pub. No.: US 2024/0241559 A1
(43) Pub. Date: Jul. 18, 2024

(54) DYNAMIC POWER SHARING UTILIZING POWER EVENT FEEDBACK

(71) Applicant: Intel Corporation, Santa Clara, CA (US)

(72) Inventors: Rob Sims, Forest Grove, OR (US); Deepak Ganapathy, Folsom, OR (US); Sivasankara Reddy Juturu, Hillsboro, OR (US); Sudheer Nair, Portland, OR (US)

(21) Appl. No.: 18/619,538

(22) Filed: Mar. 28, 2024

(51) Int. Cl. G06F 1/28; G06F 1/3206

(52) U.S. Cl. CPC G06F 1/28; G06F 1/3206

(57) ABSTRACT

Techniques are described for incorporating telemetry related to power source loading and the frequency of power-control events as part of a power balancing algorithm to control an electronic devices' power budgeting among devices sharing a common power source. The techniques utilize telemetry and control loop algorithms to dynamically balance the power between two or more electronic components, which may include a CPU and a GPU. The techniques as described herein function to monitor power source loading as well as the frequency of a predetermined set of events, which may include performance and/or power control events. Based on this information, the power budgets of the devices may be dynamically adjusted up or down to maximize performance, in contrast with the conventional usage of artificial static performance caps.

### BACKGROUND

Many electronic device platforms are limited with respect to the size of a power source, such as a power supply unit (PSU) or battery charger, that may be connected internally or externally. Because of this, active power management is often required to ensure that a device power source does not become over-taxed, resulting in an unexpected shutdown. Such active power management techniques typically include controlling the power consumption of the system's CPU (IA cores), and potentially the GPU. However, conventional active power management algorithms do not account for power source loading when determining the power targets for the CPU and GPU, and instead focus on either the temperature levels of the CPU and GPU or telemetry related to a system battery. Therefore, to protect the power source, system designers need to apply static power limits on the CPU and GPU, regardless of whether the power source is heavily loaded or has extra headroom. Thus, current techniques for controlling a shared budget of device components, such as a CPU and GPU, are inadequate.

### BRIEF DESCRIPTION OF THE DRAWINGS/FIGURES

The accompanying drawings, which are incorporated herein and form a part of the specification, illustrate the present disclosure and, together with the description, further serve to explain the principles and to enable a person skilled in the pertinent art to make and use the techniques discussed herein.

In the drawings, like reference characters generally refer to the same parts throughout the different views. The drawings are not necessarily to scale, emphasis instead generally being placed upon illustrating the principles of the disclosure. In the following description, reference is made to the following drawings, in which:

FIG. 1 illustrates a conventional thermal-based solution for adjusting the power budget shared between two devices;

FIG. 2 illustrates a power sharing flow for adjusting the power budget shared between two devices based upon the occurrence of power protection events, in accordance with the disclosure;

FIGS. 3A and 3B illustrate power rebalancing loops used for adjusting the power budget shared between two devices, in accordance with the disclosure;

FIG. 4 illustrates another view of the power budget adjustments made by the power balancing algorithm in response to the frequency of power monitoring event occurrences over time;

FIG. 5 illustrates a power sharing flow for adjusting the power budget shared between two devices that adapts a frequency of event monitoring, in accordance with the disclosure; and

FIG. 6 illustrates an electronic device, in accordance with the disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

### I. Technology Overview

The disclosure is directed generally to the dynamic adjustment of power budgets for electronic device components and, in particular, to techniques for dynamically adjusting the power budgets of electronic device components that share a common power source using power event feedback.

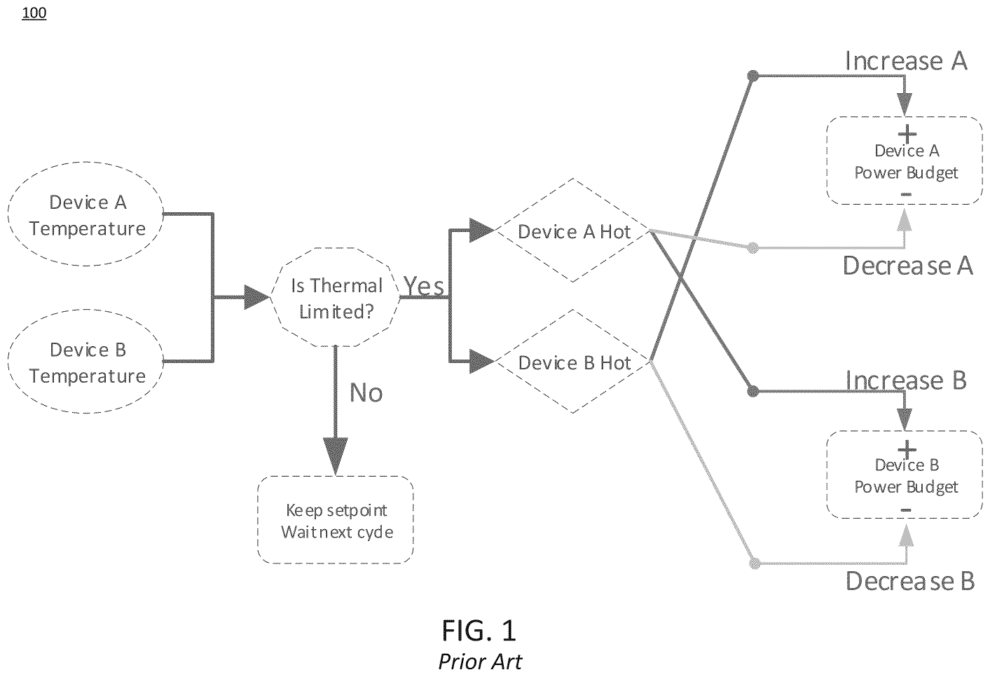

Again, conventional power source protection techniques have drawbacks that require static power requirements to be placed on electronic device component power budgets such as CPUs and GPUs. Moreover, current control mechanisms for balancing CPU and GPU power are based on temperature and battery telemetry. For example, FIG. 1 illustrates a conventional thermal-based solution for adjusting the power budget that is shared between two devices. As shown in FIG. 1, conventional solutions receive thermal monitoring information that indicates whether a particular electronic component (i.e. device A or B, which again may comprise a CPU and GPU, respectfully) is thermally limited. If not, then the current power budget for each device A, B is maintained until the next monitoring cycle, which may comprise a periodic sampling “window.” However, if either of the devices A, B is in a thermally-limited state (i.e. “hot”), then the conventional solution as shown in FIG. 1 functions to increase the power budget of the other non-thermally-limited device while decreasing the power budget of the thermally-limited device.

But to the extent that current solutions are implemented for protecting the power source, such control mechanism only manage CPU power consumption, and thus the CPU bears the full burden of such control management techniques. Moreover, such conventional solutions are unaware of system-level power protection events, as only thermal data is available and used for such conventional power-balancing algorithms. This reduces performance by throttling the CPU in isolation of the GPU performance.

The techniques described herein address these issues by recognizing that increased performance may be achieved by incorporating telemetry related to the power source's loading and the frequency of power-control events into an electronic devices' active management policies. To do so, the techniques described in further detail herein utilize new telemetry and control loop algorithms to dynamically balance the shared power budget between two or more electronic components, which may include the CPU and GPU. This allows for an overall higher level of system performance to be achieved while still protecting the power source from going into an over-current protection mode. The algorithms as described herein function to leverage power source loading as well as the frequency of a predetermined set of power protection events, which may include performance-related and/or power control events. Thus, the power source loading monitoring is used to create the power event notifications as discussed in further detail herein, which may comprise the presence or absence of power protection events. The power source loading monitoring may be performed via code that is executed locally on a CPU, with the details regarding this functionality being discussed in further detail below. This may include, in various non-limiting and illustrative scenarios, the executed code reading from a suitable voltage controller, and storing the event data into a register that a system-level power tuning application may then access (i.e. read). Additionally or alternatively, other suitable type of data, such as raw power source loading, could also be monitored via the system-level power tuning application. In any event, based on this information, the operational limit, i.e. the power budgets of the electronic components, may be dynamically adjusted up or down to maximize performance, in contrast to the conventional use of artificial static performance caps.

The dynamic management of the power budget of the electronic device components as discussed herein allows overall for the system performance to be higher and to render a better user experience. Without this approach, the conventional power source protection methods solely reduce CPU performance to reduce system power. The performance management techniques described herein, however, function to balance the system power protection across both the CPU and the GPU (or other suitable components). This allows for the design of higher-performing products that utilize higher thermal design power (TDP) CPUs and GPUs while maintaining a smaller power source (such as a PSU) than would otherwise be possible.

The details of the power management techniques are further described below in separate Sections for ease of explanation. However, it is noted that the presentation of the power control management techniques in this manner is not intended to imply that the implementation of these techniques is limited to the techniques described in a single Section. Instead, the techniques for power management control as further described herein in any number of the following Sections may be combined with one another. Furthermore, the power control techniques are described herein with respect to a CPU and a GPU as a non-limiting and illustrative scenario. The techniques as described herein may be implemented with any suitable number of electronic components (also referred to herein as devices) that share a common power supply such that a per-device power budget may be adjusted for any suitable number of electronic components via the power balancing control techniques as discussed herein.

### II. The Use of System Power Protection Events for Power Balancing

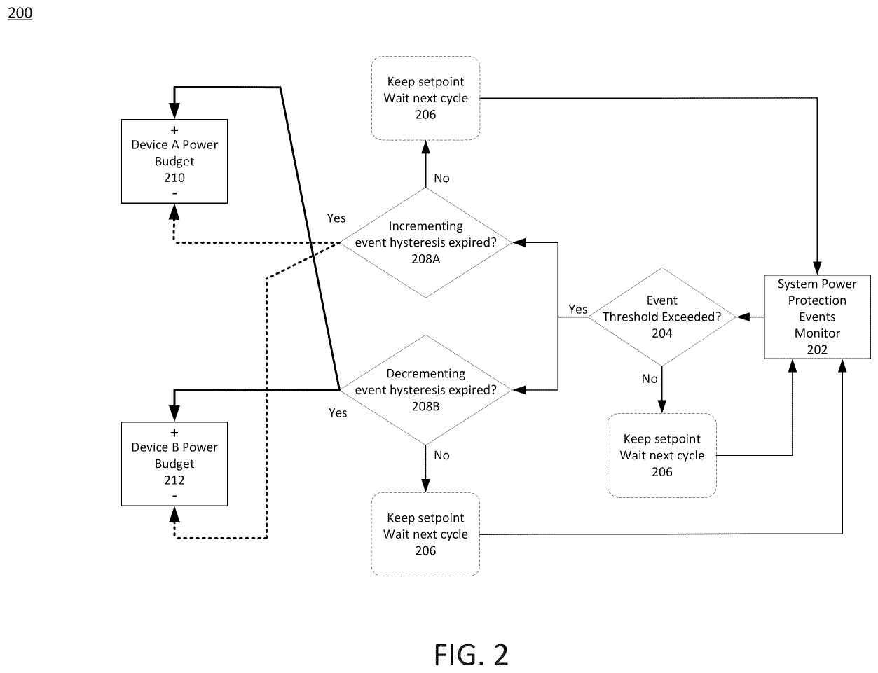

FIG. 2 illustrates an example process flow for adjusting the power budget shared between two devices based upon the occurrence of power protection events, in accordance with the disclosure. As discussed in further detail herein, the flow 200 as shown in FIG. 2 may describe a process flow for a power-balancing algorithm that utilizes system-level power protection events to adjust electronic component power budgets accordingly. The various blocks as shown in FIG. 2 are discussed in further detail herein with respect to their respective functions. It is noted that the functionality provided by the blocks as shown in FIG. 2 may be implemented via any suitable combination of hardware and software components. The software in this context may be executed via any suitable platform in which the electronic components (i.e. the devices A, B) are implemented.

To provide various illustrative and non-limiting scenarios, device A may comprise a CPU and device B may comprise a GPU, as discussed herein. However, the techniques as described herein are not limited to such implementations, and the power balancing techniques as discussed herein may be implemented to adjust the power budgets of any suitable number and/or type of components that share a common power source. Thus, although the devices A, B are primarily described herein in terms of implementation as a CPU and GPU, the devices A, B may alternatively be implemented as any suitable type of processor having a power budget, USB-C ports, memory, storage, peripheral devices, etc. Moreover, the power balancing techniques as discussed herein may be implemented in accordance with any suitable type of power source that is shared among any suitable number of devices, the power source functioning to supply power in a dynamic fashion over time based upon various loading requirements. This may include a PSU, a battery charger, etc.

When the devices A, B are implemented as a CPU and a GPU, the CPU may perform lower-level power source monitoring using onboard and/or integrated firmware, which may comprise a power-event monitoring algorithm that is executed locally on the CPU. This power-event monitoring algorithm may be implemented in conjunction with a conventional thermal-based power budget adjustment algorithm as discussed above with respect to FIG. 1. Thus, the process flow 200 as shown in FIG. 2, which again may be implemented via a power-balancing algorithm, leverages the CPU' s locally-executed power-event monitoring data to perform higher system-level power budget adjustments as discussed in further detail herein. As a result, the various power device budget adjustments as discussed herein may be implemented independently or in parallel with thermal-based power budget adjustments, such as those discussed above with respect to FIG. 1.

To do so, the CPU may implement any suitable locally-executed power-event monitoring algorithm to write power protection data to any suitable memory location, such as a register or other addressable memory location that is known by the higher, system-level software that executes the power-balancing algorithm in accordance with the process flow 200 as further discussed herein. To provide an illustrative and non-limiting scenario, the power protection data may comprise power protection events that are triggered in response to various conditions being met, which are initiated by the CPU for power source protection. Such power protection events may then be written to any suitable memory location as noted above based upon the monitoring performed via the CPU's locally-executed power-event monitoring functionality.

To provide an illustrative and non-limiting scenario, this may include the CPU observing a power source output (such as a PSU output) above a predetermined threshold, triggering the CPU's power protection algorithm to reduce the CPU's operating power in various ways, as discussed in further detail below. However, the CPU's power protection algorithm only affects the CPU's power consumption. Thus, the power protection events identified by the CPU's power protection algorithm in this way are passed up to the system level and accessed (i.e. read) by the higher-level software running on the electronic device. Therefore, the system power protection events monitor block 202 represents the functionality associated with the power protection events being read by the higher-level software from a suitable memory location after being stored by the CPU, which may occur as part of a power-balancing algorithm that is represented by the process flow 200.

In other words, the CPU's power protection algorithm provides a first level of protection from power source's (such as a PSU) over-current events, but is limited to only adjusting the CPU's operating power limits The power balancing algorithm represented by the process flow 200, on the other hand, enables an adjustment to both device power budgets in parallel to yield the best overall performance. And by making the power balancing algorithm aware of the power protection events at the system level, the power balancing algorithm may dynamically adjust device performance based on system activity other than CPU-triggered events, such as loading that may occur due to attached system peripherals. Therefore, the term “power protection events” as used herein may comprise any suitable type of information, in addition to or instead of the CPU-triggered events, which are relevant for adjusting the power budgets of any suitable devices sharing a common power source. In this way, FIG. 1 represents a shift of thermal budget that results in only shifting the power budget of one of the devices A, B up or down in response to a single event, whereas the power balancing algorithm represented by the process flow 200 allows for the power budget of both devices A, B to be adjusted up or down in response to additional, non-thermal power protection events.

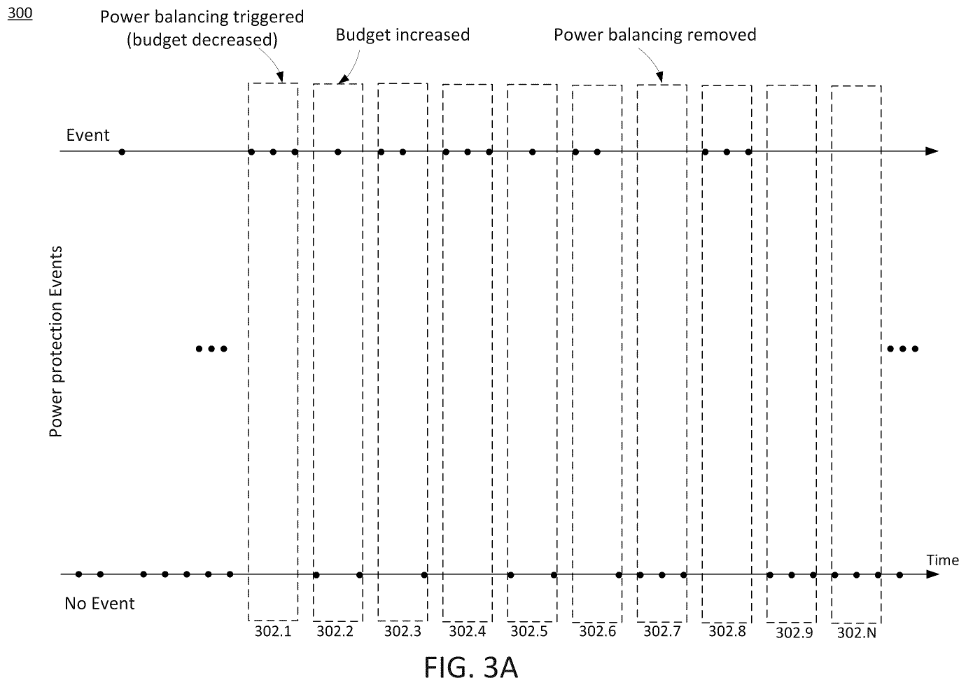

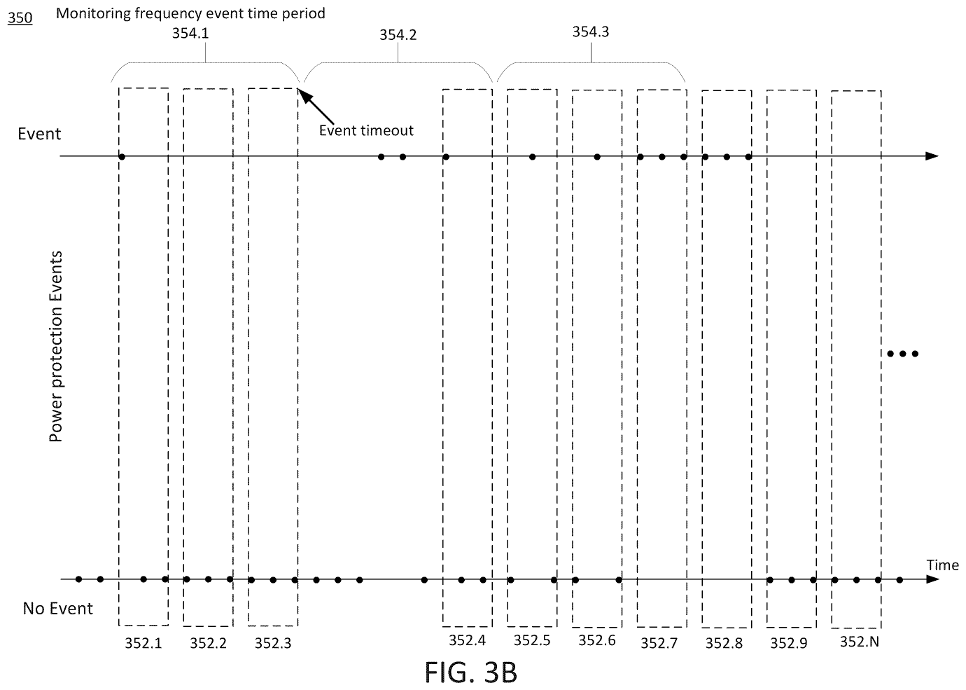

In other words, the power balancing algorithm as discussed herein implements a control loop to continuously monitor the frequency of the power protection events and to adjust the power budgets of the devices A, B up or down to achieve an acceptable rate of power protection events. FIGS. 3A-3B illustrate non-limiting and illustrative scenarios in which the power balancing algorithm utilizes this control loop process to continuously adjust the power budgets of the devices A, B to their optimal levels to ensure system stability and a good user experience.

To do so, it is noted that each time the power balancing algorithm invokes a power budget adjustment, such an event is also logged to a suitable storage location (which may be the same location or a different location than the power protection events). This storage location is also monitored by the higher-level system software as part of the execution of the power balancing algorithm as discussed herein. And by measuring how often the power protection events occur within each sampling window, the power balancing algorithm determines whether the power budgets of the devices A, B are set too high for the current loading on the overall system.

To provide a non-limiting and illustrative scenario, it is noted that the power balancing algorithm accesses the stored power event data on a periodic basis. The power balancing algorithm is initially triggered when the frequency of power protection events is such that the number of power protection events that occur over an event threshold detection sampling window exceeds a predetermined threshold event number. Then, based on a predetermined threshold limit of power events that occur within each sampling period, the power balancing algorithm determines whether “too many” events have occurred or if fewer/no events have occurred. The power balancing algorithm then takes action to either adjust the power budgets of the devices A, B downward or upward. This control loop process thus continuously attempts to keep the power budgets of the devices A, B as high as possible. Additional details regarding this process are further discussed below.

Again, the power balancing algorithm represented by the process flow 200 illustrates the power behavior of a system containing two devices that share a common power source. The power balancing algorithm periodically accesses the stored power event data in accordance with successive monitoring (also referred to herein as “sampling”) periods of any suitable length, which are illustrated in FIGS. 3A and 3B as the sampling periods 302.1-302.N and 352.1-352.N. The power balancing algorithm determines a number of power protection events occurring within each sampling period, and then determines whether to adjust the power budgets of the devices A, B up or down based upon a number of power protection events that occur over time within these sampling periods, as discussed in further detail below. The power balancing algorithm thus enables a selective adjustment of the operational power limits of the devices A, B based upon an occurring frequency of the power protection events over the plurality of sampling periods.

With continued reference to FIGS. 3A and 3B, the number of power protection events occurring with each sampling period 302.1-302.N and 352.1-352.N is used to drive a decision by the power balancing algorithm regarding whether to increase the power budget, decrease the power budget, or remain at the current power budget without any changes. It is noted that the number of occurrences that triggers each response may be different so as to avoid oscillatory behavior. In other words, hysteresis is implemented such that the number of power protection events that occur within a sampling period resulting in an increase in power budgets is different than the number of power protection events that occur within a sampling period resulting in a decrease in the power budgets.

For ease of explanation, the following illustrative scenario is used in which the number of power protection events that occur within a sampling period resulting in an increase in power budgets is set to one. The number of power protection events that occur within a sampling period resulting in a decrease in power budgets is set to three. The number of power protection events that occur within a sampling period resulting in no change to the current power budgets is set to two. It is noted that any suitable thresholds may be defined in this manner to support the adjustment of device budgets while avoiding instability and/or oscillatory behavior. For instance, and with continued reference to FIG. 3A, the sampling periods 302.1, 302.4, and 302.8 each include three power protection events, and thus power balancing is used in response to balance the budgets downward. However, the sampling periods 302.2 and 302.5 include a single power protection event, and thus power balancing is used in response to balance the budgets downward. For the sampling periods 302.3 and 302.6, the hysteresis conditions have not been met with respect to the number of events that occurred within a previous sampling window, and thus the number of events within these sampling periods is considered insufficient to adjust the current power budget. Finally, the sampling periods 302.7, 302.9, and 302.N each include no power protection events, and thus the power balancing may be removed altogether or, alternatively, the power budgets once again increased from their previous settings.

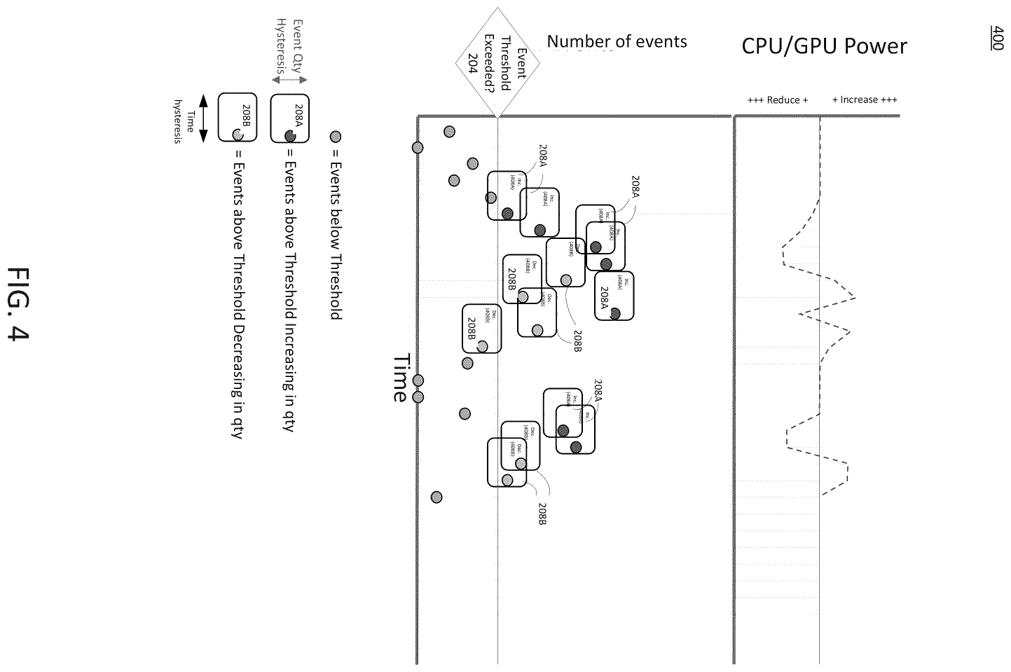

Continuing this scenario with these event number thresholds in mind, the power balancing algorithm first determines (block 204) whether an initial event threshold number has been exceeded. In other words, the power balancing algorithm continues to monitor the power protection events during each sampling period 302.1-302.N until an initial threshold of events is exceeded. This is also illustrated in FIG. 4 by way of the defined threshold and the reference to the block 204. Until this occurs, the power protection algorithm may remain in an inactive state in which the power protection events are continuously monitored during each sampling period 302.1-302.N, but no adjustments are made to the device power budgets, as represented by the “No” path from the block 204 to the block 206 as shown in FIG. 2. However, once the initial power protection device threshold is met, then the power balancing algorithm begins applying power budget reductions to the devices A, B. In this case, a determination is then made regarding whether a sufficient number of power protection events has occurred within each current sampling period 302.1-302.N to warrant any additional adjustments to the device power budgets. For the current scenario, for ease of explanation this threshold event number may comprise one power protection event such that, when no power protection events have occurred within a current sampling window, no changes are made to the current power budget setpoint, and the process flow 200 repeats this process for the next sampling period (block 206).

However, if one or more power protection events have occurred within the current sampling period (block 208A, yes), then the process flow 200 continues to make further determinations regarding whether the increasing event hysteresis (block 208A) or the decreasing event hysteresis (block 208B) has expired. This is illustrated in further detail in FIG. 4, which plots a number of power protection events over time. As shown in FIG. 4, once the initial event threshold number is crossed (block 204), if the number of power protection events still increases further, then stronger power reduction is applied (208A). However, if the number of power protection events starts to decrease (but still remains above the initial event threshold number (block 204)), then the power reduction is decreased (408B). It is noted that the various power protection event thresholds as discussed with respect to FIGS. 3A and 3B are different than those shown in FIG. 4. This has been done to demonstrate the use of power protection event thresholds over an uncluttered event time scale as shown in FIGS. 3A and 3B.

It is noted that the power balancing algorithm may also consider “non-events,” when determining whether to adjust the power budgets and/or to suspend the use of the power balancing algorithm as noted herein. Thus, FIG. 4 shows several instances during which time the number of events is zero, i.e. only non-events as shown at the bottom portion of FIGS. 3A-3B have occurred. Thus, in addition or instead of the satisfaction of the event threshold number being exceeded (block 204), the power balancing algorithm may utilize the number of non-events being below a threshold value to suspend and/or adjust the power balancing as discussed herein.

Furthermore, and with continued reference to FIG. 4, the use of hysteresis via the power balancing algorithm as described herein may leverage both event-based (i.e. the number of events within a sampling period) as well as a time-based hysteresis (i.e. a time-based dependence of both the present and past frequency of event occurrences). In other words, the power balancing algorithm as discussed herein may use both the amplitude (number of events) as well as time (the number of prior sampling periods), and thus may function analogously to a low-pass filter. This is illustrated in FIG. 4 via the time hysteresis represented in the x-axis in addition to the event hysteresis in the y-axis. Thus, and to provide an illustrative and non-limiting scenario, the increases in the frequency of event occurrences over time may be considered in addition to the number of events occurring with each individual sampling period such that the power balancing algorithm may adjust the power budgets using a larger “step” when the time-based hysteresis indicates a larger “jump” in the increasing or decreasing number of power protection events.

Thus, and continuing the current scenario with respect to FIG. 3A, it is assumed that the one power protection event that occurs within the sampling period 302.1 triggers the power balancing algorithm, i.e. the result of block 204 is “yes.” Then, during the sampling period 302.4, a total of three power protection events have occurred. Thus, during the subsequent cycles (i.e. sampling periods) it is not only determined at block 204 that the threshold number of power protection events (one) has been met or exceeded, but that a further threshold (three) of increasing power protection events has also been met or exceeded. In this case, at block 208A, a determination is made that the number of power protection events is greater than or equal to the increasing event hysteresis threshold (i.e. three), and thus the power budgets of both devices A, B are decreased.

Continuing the current scenario with respect to FIG. 3A, a total of one power protection event then occurs during the next sampling period 302.5. Thus, it is determined at block 204 that the threshold number of power protection events (one) has still been met or exceeded, and at block 208B, a determination is made that number of power protection events are decreasing in quantity. That is, although the total number of power protection events is greater or equal to the initial event threshold of one, the number of power protection events is less than or equal to a further threshold, i.e. a decreasing event hysteresis threshold of one, indicating a decrease in power protection event frequency over time. As a result, the power budgets of both devices A, B are increased.

Furthermore, once the number of power protection events goes below the initial event threshold of one such that no power protection events are determined, which in this case occurs during the sampling period 302.7, the budget power reduction is removed fully. In this way, the larger the “jump” in the increasing or decreasing number of power protection events, the stronger the reaction of the power balancing algorithm. Thus, because the power balancing algorithm utilizes different power protection event thresholds in this manner for the adjustment of the power budget if the devices A, B up or down, the power balancing leverages a hysteresis band that represents a number power protection events that are required to be present during a current sampling window to cause any change in the power budgets of the devices A, B from a prior state. Therefore, if a subsequent power protection event count (that is above the initial event threshold determined by block 204) is within the hysteresis band, then the power budgets of the devices A, B are held constant for that current sampling period, which helps reduce oscillations.

That is, the use of hysteresis in this manner ensures that the number of power protection events that occur between successive sampling periods is significantly changed from the previous one that triggered a power budget adjustment. Therefore, and continuing the current scenario with reference to FIG. 3A, the next sampling period 302.6 contains a total of two power protection events. Although this does result in the initial event threshold being exceeded (block 204, yes), the conditions of neither the incremented hysteresis determination block 208A nor the decremented hysteresis determination blocks 208B are met (i.e. no for both), resulting in the current power budget being maintained (block 206) which, in this case, is the increased power budget resulting from the power protection events that occurred within the prior sampling period 302.5.

The process flow 200 may thus continue until the occurrence of the sampling period 302.7, during which no power protections were recorded, and thus the power balancing algorithm may remove all power budget adjustments until the next sampling periods 302.8, during which three power protection events were recorded. As a result, the conditions of the incremented hysteresis determination block 208A are once again met, resulting in a reduction to the power budget of the devices A, B. This process of monitoring the power protection event occurrences for subsequent sampling periods continues in this manner.

Thus, the power balancing algorithm adjusts the power budget of the devices A, B to increase and decrease the power budgets such that, in each case, the total shared power budget for device A and device B does not exceed a predetermined wattage. Accordingly, the power balancing algorithm will still attempt to allocate individual device power budgets based on workload demand. However, if power protection events are observed greater than or equal to a certain frequency of occurrences threshold (i.e. the increasing event hysteresis threshold of three used above), the power balancing algorithm adjusts the power budgets of both device A and device B downward. Moreover, when the power protection events drop at or below a different threshold (i.e. the decreasing event hysteresis threshold of one used above), then the power balancing algorithm adjusts the power budgets of both device A and device B upward.

To provide an illustrative and non-limiting scenario, for the process flow as shown in FIG. 2, the initial power budget for the devices A+B is assumed to be set to 300W, with device A allocated 100W and device B allocated 200W. However, due to increases in Rest-of-Platform (RoP) power consumption, a PSU may reach and sometimes exceed its standard output rating, and thus the CPU's locally-executed power-event monitoring functionality may implement power-reduction actions as power protection events. The power balancing algorithm detects these events and determines that it should lower total system power by 50W (device A+B=250W). Based on the applications running on the system, the power balancing algorithm decides to maintain the original 33%/66% assignment of the power budget. Therefore, the power balancing algorithm lowers device A power to 83W and device B to 167W, continuing to monitor future power protection events via the subsequent sampling periods as noted above. If the 50W power reduction was insufficient, and more power protection events are occurring, then the power balancing algorithm may further reduce total system power by another 50W (device A+B=200W), and set device A to 66W and device B to 134W. When the RoP power consumption decreases, the power balancing algorithm will then detect no further power protection events and will start to adjust the power budgets of device A and device B upward. This process will then continue until the system has returned to maximum power budget levels.

It is noted that because many form-factor systems have power sources (such as PSUs) that are limited in size/capacity, these cannot support worst-case power-load conditions, and therefore must be protected from unexpected shutdowns. The power balancing algorithm as discussed herein enables the system to achieve overall higher performance by avoiding a condition in which the CPU is throttled in isolation of the GPU, and thus bears the full burden of the power source protection.

It is noted that FIG. 3A illustrates that the power balancing algorithm as discussed above implements the plurality of sampling periods 302.1-302.N, each being associated with an event-monitoring frequency. In other words, the power protection events are monitored by way of the power balancing algorithm periodically accessing the stored power protection events during each sampling period 302, with the periodicity of the sampling periods 302.1-302.N thus defining the power event monitoring frequency. As shown in FIG. 3A, the plurality of sampling periods 302.1-302.N are successive and closely time-adjacent to one another, although this is shown as a non-limiting and illustrative scenario. In other words, the control loop implemented by the power balancing algorithm as shown in FIG. 3A is executed via the periodic monitoring of the power protection events during each successive sampling period 302.1-302.N, with each successive sampling period 302.1-302.N as shown in FIG. 3A starting after the prior sampling period has ended. Although a small time period is shown in FIGS. 3A and 3B between each successive sampling period 302.1-302.N for ease of illustration, each successive sampling period 302.1-302.N may start immediately after the previous one, excepting for processing and/or other system delays.

However, the monitoring frequency of the control loop implemented by the power balancing algorithm may be of any suitable frequency, may utilize sampling periods of any suitable length, and the monitoring frequency may be adjusted over time based upon any suitable number of power protection events occurring within a previous threshold time period. That is, the power balancing algorithm may alternate between the use of slower monitoring control loops and faster monitoring control loops in response to changes in the frequency of the occurrence of power protection events over time. This is illustrated by comparing the frequency of the sampling periods 302, 352 as shown in FIGS. 3A and 3B.

For instance, the power balancing algorithm identified with the sampling periods 302.1-302.N as shown in FIG. 3A utilizes a “fast” control loop monitoring frequency for the entirety of the sampling periods 302.1-302.N. However, FIG. 3B illustrates that the power balancing algorithm may switch between a fast control loop monitoring frequency and a slower control loop monitoring frequency. To demonstrate this, continued reference is made with respect to FIG. 3B, which illustrates the use of a monitoring frequency event time period 354. The monitoring frequency event time period 354 may be defined as any suitable predetermined time period that is used to determine an occurrence of power protection events to trigger changes between the fast and slow monitoring control loop monitoring frequency implemented by the power balancing algorithm. To provide a non-limiting and illustrative scenario, the monitoring frequency event time period 354 may be a time period equal to a predetermined number of sampling periods 352.1-352.N. As another non-limiting and illustrative scenario, the monitoring frequency event time period 354 may be a predefined time period such as a counter expiration, which is initiated when any power protection event is identified upon accessing the power protection events during any sampling period 352.1-352.N.

In any event, the power balancing algorithm determines a number of power protection events during each monitoring frequency event time period, which may be compared to a predetermined event threshold value. The predetermined event threshold value for triggering the transition from the fast monitoring control loop monitoring frequency to the slow monitoring control loop monitoring frequency may be the same as the predetermined event threshold value for triggering the transition from the slow monitoring control loop monitoring frequency back to the fast monitoring control loop monitoring frequency. Alternatively, the predetermined event threshold value for triggering the transition from the fast monitoring control loop monitoring frequency to the slow monitoring control loop monitoring frequency, and vice-versa, may be different than one another, to implement a hysteresis for this purpose and avoid oscillatory behavior.

Referring back to FIG. 3B, it is shown that the power balancing algorithm is initially operating in accordance with a fast monitoring control loop monitoring frequency. However, the number of power protection events that occur over the monitoring frequency event time period 354.1 are assumed to be less than a predetermined threshold event value, and thus the event timeout period 354.1 is shown that triggers the transition to the slow monitoring control loop monitoring frequency. As a result, the next sampling period 352.4 occurs after the previous sampling period 352.3, but at a delayed time afterwards, as shown in FIG. 3B. Thus, the time difference between the sampling periods 352.3, 352.4 may define the slow monitoring control loop monitoring frequency. The monitoring frequency event time period 354 may also be used as a time period to determine whether a threshold number of power protection events have been exceeded, as discussed above with respect to block 204. In this scenario, the power balancing algorithm may suspend monitoring altogether until a threshold number of power monitoring events are once again detected within a future monitoring frequency event time period, thereby triggering the power balancing algorithm to once again operate in accordance with the fast monitoring control loop monitoring frequency.

For instance, and as shown in FIG. 3B, the number of power protection events that occur over the next monitoring frequency event time period 354.2 are assumed to be greater than a predetermined threshold event value, and thus a transition from the slow (or suspended) monitoring control loop monitoring frequency back to the fast monitoring control loop monitoring frequency is triggered. As a result, the next sampling periods 352.5-352.N once again occur one after the other with a smaller time delay (or immediately after one another), as shown in FIG. 3B. This process continues such that the power balancing algorithm may alternate between these different control loop monitoring frequencies based upon a history of the frequency of occurrences of the power protection events over time.

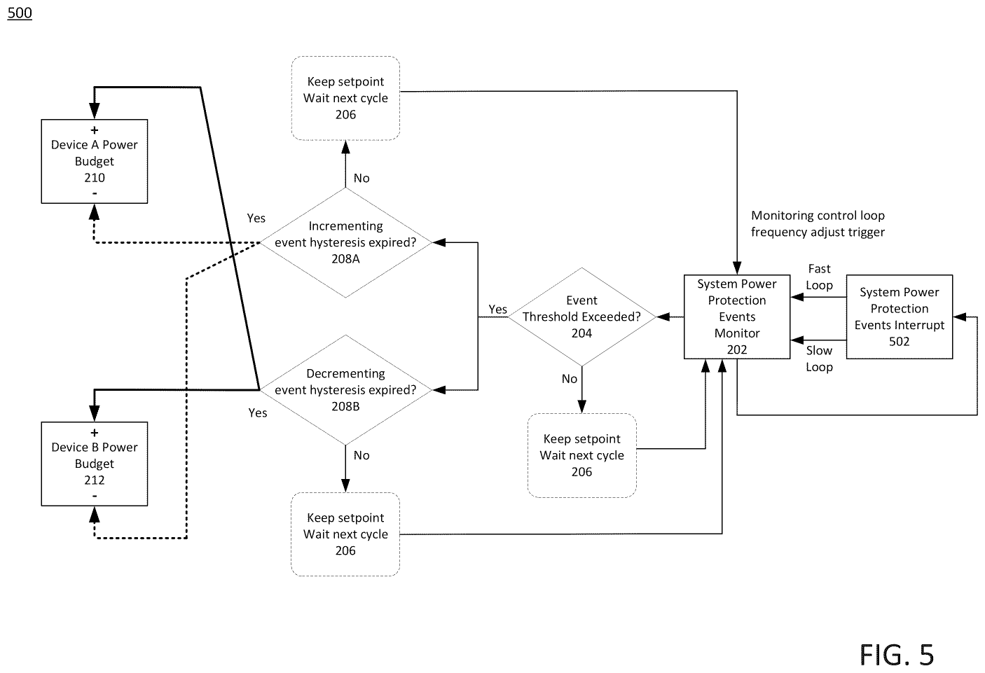

FIG. 5 illustrates a power sharing flow for adjusting the power budget shared between two devices that adapts a frequency of event monitoring, in accordance with the disclosure. The process flow 500 as shown in FIG. 5 is identical to the process flow 200 as shown in FIG. 2, with analogous blocks being shown in each of the FIGS. 2 and 5 performing the same functions as one another. However, the process flow 500 as shown in FIG. 5 indicates that the system power protection events monitor block 202 may operate in accordance with different monitoring control loop monitoring frequencies, as discussed above. Although only two different frequencies are shown and discussed herein, it is noted that the process flow 500 may implement any suitable number of control loop monitoring frequencies, each being identified with a respective predetermined power protection event threshold value.

The “fast loop” and “slow loop” lines as shown in FIG. 5 thus corresponds to a determination that the current control loop monitoring frequency is to be adjusted. It is noted that the identification of the power control events within each monitoring frequency event time period, as well as the decision to adjust the control loop monitoring frequency, may be generated via the power balancing algorithm itself or, alternatively, via another component within the system in which the power balancing algorithm is implemented. As a non-limiting and illustrative scenario, a CPU may generate (e.g. as part of its locally-executed power event monitoring functionality) an interrupt (block 502) to signal a switch to faster control loop monitoring behavior if a predetermined threshold number of power control events within a monitoring frequency event time period is exceeded, as noted above. Additionally or alternatively, the interrupt may be generated (block 502) via a lower-level System Power Protection Manager.

The power budgets of the devices A, B may alternatively be referred to herein as an operational power limit, and may be adjusted and/or defined in accordance with any suitable techniques, including known techniques. The operational power limit may be defined, in a non-limiting and illustrative scenario, in accordance with a correlated maximum performance limit such that adjustments to the performance limit of the devices A, B results in a corresponding adjustment to the power budgets, as discussed herein. Alternatively, the operational power limit may be defined in accordance with a predefined maximum power consumption limit

Regardless of how the power budget is defined, the power budget may be adjusted in accordance with any suitable adjustment to power parameters that are implemented via the devices A, B. Thus, in one non-limiting and illustrative scenario, the devices A, B may operate in accordance with predefined performance limits, which may be adjusted from a maximum performance limit of 100% to a reduced performance limit of 80%, 50%, etc. Additionally or alternatively, the power budgets may be adjusted via a clock frequency adjustment implemented by the device A and/or B to a slower clock frequency, and/or a reduction in the maximum allowed operating temperature (which in turn results in a decrease in the performance of the respective device). As an illustrative and non-limiting scenario, the frequency of a CPU may be dropped to a Low-Frequency-Mode (LFM) level in accordance with a downward adjustment of its power budget as discussed herein.

Additionally or alternatively, the power budgets may be adjusted by leveraging existing power balancing algorithms that are implemented via one of the devices A, B (such as a CPU). This may include, in some non-liming and illustrative scenarios, adjusting performance limits of the devices A and/or B in accordance with one or more different time scales. These performance metrics may be associated with a locally-executed power control algorithm implemented via a CPU and/or GPU that defines several different time scales for performance limiting. This may include “long-term” or expected steady state power consumption of a processor, which may comprise the thermal design power (TDP) or other suitable performance limit defined over a long-term time scale on the order of several milliseconds. Additional performance limit time scales may comprise shorter-term performance limits, which may define a short-term maximum power draw for a processor. This number is typically higher than the long-term expected steady state power consumption, and a CPU may enter into this state when a workload is applied to allowing the CPU to use up to the short-term maximum power draw on a shorter time scale of several microseconds.

The power balancing algorithm as discussed herein may adjust the power budgets of the devices A, B as shown in FIG. 2 in accordance with any combination of the techniques as discussed herein, which may include modifying the long-term and short-term maximum power draw values. In this way, the power balancing algorithm as discussed herein may adjust the performance limits of the devices A, B across different time scales to influence the system's performance and power behavior.

### III. An Electronic Device

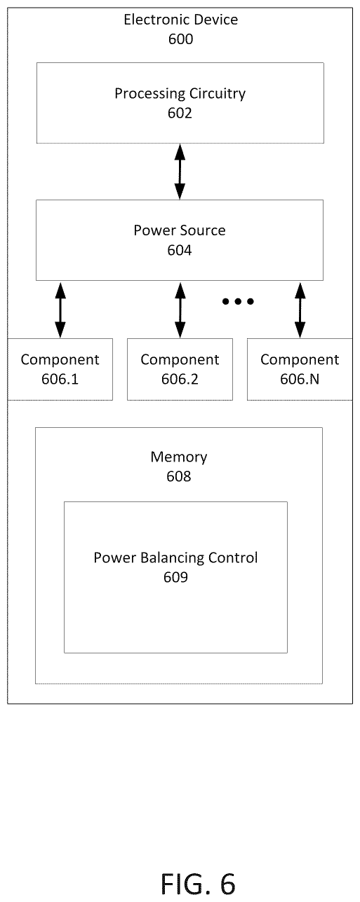

FIG. 6 illustrates an electronic device, in accordance with the disclosure. The electronic device 600 may be identified with any suitable type of device that implements the power balancing techniques as discussed herein, which may be to adjust the power budgets of any suitable encumber and/or types of components that share a common power source. To provide some illustrative and non-limiting scenarios, the electronic device 600 may be implemented as a wireless device, a user equipment (UE), a mobile phone, a laptop computer, a tablet, a wearable device, etc.

The electronic device 600 may comprise processing circuitry 602, which may be configured as any suitable number and/or type of computer processors, and which may function to control the electronic device 600 and/or other components of the electronic device 600. The processing circuitry 602 may be identified with one or more processors (or suitable portions thereof) implemented by the electronic device 600. The processing circuitry 602 may be identified with one or more processors such as a host processor, a digital signal processor, one or more microprocessors, a central processing unit (CPU), baseband processors, microcontrollers, an application-specific integrated circuit (ASIC), part (or the entirety of) a field-programmable gate array (FPGA), etc. The processing circuitry 602 may be identified with the CPU and/or one of the devices A, B as discussed herein. The processing circuitry 602 may utilize power provided by the power source 604.

The processing circuitry 602 may be configured to carry out instructions to perform arithmetical, logical, and/or input/output (I/O) operations, and/or to control the operation of one or more components of electronic device 600 to perform various functions as described herein. The processing circuitry 602 may include one or more microprocessor cores, memory registers, buffers, clocks, etc., and may generate electronic control signals associated with the components of the electronic device 600 to control and/or modify the operation of these components. The processing circuitry 602 may communicate with and/or control functions associated with the memory 608, as well as any other components of the electronic device 600. Thus, the processing circuitry 602 may generate control signals or cause other components to generate such control signals to generate and store the power protection event data, as discussed herein.

The electronic device 600 comprises a power source 604, which may be implemented as power delivery circuitry that is used to supply power to the processing circuitry 602 and one or more of the componetsn 606.1-606.N and/or to charge a battery of the electronic device 600. Thus, the power source 604 may include any suitable type of power management circuitry, power conditioners, etc., and may be configured to selectively provide power to the electronic device 600 via the external power source or the battery of the electronic device 600.

The electronic device 600 comprises any suitable number N of components 606.1-606.N. These components 606.1-606.N may be implemented as any suitable number and/or type of components that share the power source 604 with the processing circuitry 602. Thus, the components 606.1-606.N may be identified with one or more graphics processors such as a dedicated graphics processing unit (GPU), one of the devices A, B as discussed herein, or any other suitable device having a power budget that is controlled as discussed herein.

The memory 608 stores data and/or instructions such that, when executed by the processing circuitry 602 and/or other suitable processing circuitry of the electronic device 600, cause the electronic device 600 to perform various functions such as monitoring power protection events and/or adjusting the power budgets of the various components that share the power source 604, as discussed in further detail herein. The memory 608 may be implemented as any suitable type of volatile and/or non-volatile memory, including read-only memory (ROM), random access memory (RAM), flash memory, a magnetic storage media, an optical disc, erasable programmable read only memory (EPROM), programmable read only memory (PROM), etc. The memory 608 may be non-removable, removable, or a combination of both. The memory 608 may be implemented as a non-transitory computer readable medium storing one or more executable instructions such as logic, algorithms, code, etc. The instructions, logic, code, etc., stored in the memory 608 are represented by the power balancing control module 609. The processing circuitry 602 and/or other suitable processing circuitry of the electronic device 600 may execute the instructions stored in the memory 608 to enable any of the techniques as described herein to be functionally realized, which may include execution of the power balancing algorithm. The power balancing control module 609 may store computer-readable instructions that, when executed by the processing circuitry 602 and/or other suitable processing circuitry of the electronic device 600, enable the electronic device 600 to perform any of the functions as described herein with respect to the execution of the power balancing algorithm.

### IV. General Configuration of a Computer-Readable Medium

A non-transitory computer-readable medium is provided. The non-transitory computer-readable medium has instructions stored thereon that, when executed by processing circuitry of an electronic device, cause the electronic device to: determine a number of power protection events occurring within respective ones of a plurality of sampling periods, the power protection events being associated with a power source that provides power to a first component and a second component of the electronic device; and selectively adjust, based upon an occurring frequency of the power protection events over the plurality of sampling periods, an operational power limit of the first component and the second component. In addition or in alternative to and in any combination with the optional features previously explained in this paragraph, the first component comprises a central processing unit (CPU), and the second component comprises a dedicated graphics processing unit (GPU). In addition or in alternative to and in any combination with the optional features previously explained in this paragraph, the power source comprises a power supply unit (PSU), and the power protection events comprise power limiting events initiated by the first component in response to a power output of the PSU exceeding a threshold power level. In addition or in alternative to and in any combination with the optional features previously explained in this paragraph, the plurality of sampling periods are associated with an event-monitoring frequency, which are successive and time-adjacent to one another. In addition or in alternative to and in any combination with the optional features previously explained in this paragraph, the plurality of sampling periods are associated with an event-monitoring frequency, which is based upon a number of power protection events occurring within a predetermined time period. In addition or in alternative to and in any combination with the optional features previously explained in this paragraph, the instructions, when executed by the processing circuitry, cause the electronic device to increase the monitoring frequency in response to the number of power protection events occurring over the predetermined time period exceeding a threshold event number. In addition or in alternative to and in any combination with the optional features previously explained in this paragraph, the instructions, when executed by the processing circuitry, cause the electronic device to increase the operational power limit of the first component and the second component in response to a number of power limiting events occurring within one of the plurality of sampling periods being less than or equal to a first threshold event number. In addition or in alternative to and in any combination with the optional features previously explained in this paragraph, the instructions, when executed by the processing circuitry, cause the electronic device to decrease the operational power limit of the first component and the second component in response to a number of power limiting events occurring within a further one of the plurality of sampling periods being greater than or equal to a second threshold event number that is different than the first threshold event number. In addition or in alternative to and in any combination with the optional features previously explained in this paragraph, the instructions, when executed by the processing circuitry, cause the electronic device to selectively adjust the operational power limit of the first component and the second component by: decreasing the operational power limit of the first component and the second component to a decreased operational power limit when a number of power limiting events occurring within a first one of the plurality of sampling periods exceeds a first threshold event number; and increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number. In addition or in alternative to and in any combination with the optional features previously explained in this paragraph, the instructions, when executed by the processing circuitry, cause the electronic device to adjust the operational power limit of the first component and the second component by adjusting a performance limit of the first component and/or the second component in accordance with one or more different time scales.

### V. General Configuration of an Electronic Device

An electronic device is provided. The electronic device comprises a first component; a second component; memory configured to store instructions; and processing circuitry configured to execute the instructions stored on the memory to: determine a number of power protection events occurring within respective ones of a plurality of sampling periods, the power protection events being associated with a power source that provides power to the first component and the second component; and selectively adjust, based upon an occurring frequency of the power protection events over the plurality of sampling periods, an operational power limit of the first component and the second component. In addition or in alternative to and in any combination with the optional features previously explained in this paragraph, the first component comprises a central processing unit (CPU), and the second component comprises a dedicated graphics processing unit (GPU). In addition or in alternative to and in any combination with the optional features previously explained in this paragraph, the power source comprises a power supply unit (PSU), and the power protection events comprise power limiting events initiated by the first component in response to a power output of the PSU exceeding a threshold power level. In addition or in alternative to and in any combination with the optional features previously explained in this paragraph, the plurality of sampling periods are associated with an event-monitoring frequency, which are successive and time-adjacent to one another. In addition or in alternative to and in any combination with the optional features previously explained in this paragraph, the plurality of sampling periods are associated with an event-monitoring frequency, which is based upon a number of power protection events occurring within a predetermined time period. In addition or in alternative to and in any combination with the optional features previously explained in this paragraph, the processing circuitry is configured to execute the instructions to increase the monitoring frequency in response to the number of power protection events occurring over the predetermined time period exceeding a threshold event number. In addition or in alternative to and in any combination with the optional features previously explained in this paragraph, the processing circuitry is configured to execute the instructions to increase the operational power limit of the first component and the second component in response to a number of power limiting events occurring within one of the plurality of sampling periods being less than or equal to a first threshold event number. In addition or in alternative to and in any combination with the optional features previously explained in this paragraph, the processing circuitry is configured to execute the instructions to decrease the operational power limit of the first component and the second component in response to a number of power limiting events occurring within a further one of the plurality of sampling periods being greater than or equal to a second threshold event number that is different than the first threshold event number. In addition or in alternative to and in any combination with the optional features previously explained in this paragraph, the processing circuitry is configured to execute the instructions to selectively adjust the operational power limit of the first component and the second component by: decreasing the operational power limit of the first component and the second component to a decreased operational power limit when a number of power limiting events occurring within a first one of the plurality of sampling periods exceeds a first threshold event number; and increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number. In addition or in alternative to and in any combination with the optional features previously explained in this paragraph, the processing circuitry is configured to execute the instructions to adjust the operational power limit of the first component and the second component by adjusting a performance limit of the first component and/or the second component in accordance with one or more different time scales.

### EXAMPLES

The following examples pertain to various techniques of the present disclosure.

An example (e.g. example 1) is directed to a non-transitory computer-readable medium having instructions stored thereon that, when executed by processing circuitry of an electronic device, cause the electronic device to: determine a number of power protection events occurring within respective ones of a plurality of sampling periods, wherein the power protection events are associated with a power source that provides power to a first component and a second component of the electronic device; and selectively adjust, based upon an occurring frequency of the power protection events over the plurality of sampling periods, an operational power limit of the first component and the second component.

Another example (e.g. example 2), relates to a previously-described example (e.g. example 1), wherein the first component comprises a central processing unit (CPU), and wherein the second component comprises a dedicated graphics processing unit (GPU).

Another example (e.g. example 3) relates to a previously-described example (e.g. one or more of examples 1-2), wherein the power source comprises a power supply unit (PSU), and wherein the power protection events comprise power limiting events initiated by the first component in response to a power output of the PSU exceeding a threshold power level.

Another example (e.g. example 4) relates to a previously-described example (e.g. one or more of examples 1-3), wherein the plurality of sampling periods are associated with an event-monitoring frequency, which are successive and time-adjacent to one another.

Another example (e.g. example 5) relates to a previously-described example (e.g. one or more of examples 1-4), wherein the plurality of sampling periods are associated with an event-monitoring frequency, which is based upon a number of power protection events occurring within a predetermined time period.

Another example (e.g. example 6) relates to a previously-described example (e.g. one or more of examples 1-5), wherein the instructions, when executed by the processing circuitry, cause the electronic device to increase the monitoring frequency in response to the number of power protection events occurring over the predetermined time period exceeding a threshold event number.

Another example (e.g. example 7) relates to a previously-described example (e.g. one or more of examples 1-6), wherein the instructions, when executed by the processing circuitry, cause the electronic device to increase the operational power limit of the first component and the second component in response to a number of power limiting events occurring within one of the plurality of sampling periods being less than or equal to a first threshold event number.

Another example (e.g. example 8) relates to a previously-described example (e.g. one or more of examples 1-7), wherein the instructions, when executed by the processing circuitry, cause the electronic device to decrease the operational power limit of the first component and the second component in response to a number of power limiting events occurring within a further one of the plurality of sampling periods being greater than or equal to a second threshold event number that is different than the first threshold event number.

Another example (e.g. example 9) relates to a previously-described example (e.g. one or more of examples 1-8), wherein the instructions, when executed by the processing circuitry, cause the electronic device to selectively adjust the operational power limit of the first component and the second component by: decreasing the operational power limit of the first component and the second component to a decreased operational power limit when a number of power limiting events occurring within a first one of the plurality of sampling periods exceeds a first threshold event number; and increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number.

Another example (e.g. example 10) relates to a previously-described example (e.g. one or more of examples 1-9), wherein the instructions, when executed by the processing circuitry, cause the electronic device to adjust the operational power limit of the first component and the second component by adjusting a performance limit of the first component and/or the second component in accordance with one or more different time scales.

An example (e.g. example 11) is directed to an electronic device, comprising: a first component; a second component; memory configured to store instructions; and processing circuitry configured to execute the instructions stored on the memory to: determine a number of power protection events occurring within respective ones of a plurality of sampling periods, wherein the power protection events are associated with a power source that provides power to the first component and the second component; and selectively adjust, based upon an occurring frequency of the power protection events over the plurality of sampling periods, an operational power limit of the first component and the second component.

Another example (e.g. example 12), relates to a previously-described example (e.g. example 11), wherein the first component comprises a central processing unit (CPU), and wherein the second component comprises a dedicated graphics processing unit (GPU).

Another example (e.g. example 13) relates to a previously-described example (e.g. one or more of examples 11-12), wherein the power source comprises a power supply unit (PSU), and wherein the power protection events comprise power limiting events initiated by the first component in response to a power output of the PSU exceeding a threshold power level.

Another example (e.g. example 14) relates to a previously-described example (e.g. one or more of examples 11-13), wherein the plurality of sampling periods are associated with an event-monitoring frequency, which are successive and time-adjacent to one another.

Another example (e.g. example 15) relates to a previously-described example (e.g. one or more of examples 11-14), wherein the plurality of sampling periods are associated with an event-monitoring frequency, which is based upon a number of power protection events occurring within a predetermined time period.

Another example (e.g. example 16) relates to a previously-described example (e.g. one or more of examples 11-15), wherein the processing circuitry is configured to execute the instructions to increase the monitoring frequency in response to the number of power protection events occurring over the predetermined time period exceeding a threshold event number.

Another example (e.g. example 17) relates to a previously-described example (e.g. one or more of examples 11-16), wherein the processing circuitry is configured to execute the instructions to increase the operational power limit of the first component and the second component in response to a number of power limiting events occurring within one of the plurality of sampling periods being less than or equal to a first threshold event number.

Another example (e.g. example 18) relates to a previously-described example (e.g. one or more of examples 11-17), wherein the processing circuitry is configured to execute the instructions to decrease the operational power limit of the first component and the second component in response to a number of power limiting events occurring within a further one of the plurality of sampling periods being greater than or equal to a second threshold event number that is different than the first threshold event number.

Another example (e.g. example 19) relates to a previously-described example (e.g. one or more of examples 11-18), wherein the processing circuitry is configured to execute the instructions to selectively adjust the operational power limit of the first component and the second component by: decreasing the operational power limit of the first component and the second component to a decreased operational power limit when a number of power limiting events occurring within a first one of the plurality of sampling periods exceeds a first threshold event number; and increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number.

Another example (e.g. example 20) relates to a previously-described example (e.g. one or more of examples 11-19), wherein the processing circuitry is configured to execute the instructions to adjust the operational power limit of the first component and the second component by adjusting a performance limit of the first component and/or the second component in accordance with one or more different time scales.

An example (e.g. example 21) is directed to a storage means having instructions stored thereon that, when executed by processing means of an electronic device, cause the electronic device to: determine a number of power protection events occurring within respective ones of a plurality of sampling periods, wherein the power protection events are associated with a power providing means that provides power to a first component and a second component of the electronic device; and selectively adjust, based upon an occurring frequency of the power protection events over the plurality of sampling periods, an operational power limit of the first component and the second component.

Another example (e.g. example 22), relates to a previously-described example (e.g. example 21), wherein the first component comprises a central processing unit (CPU), and wherein the second component comprises a dedicated graphics processing unit (GPU).

Another example (e.g. example 23) relates to a previously-described example (e.g. one or more of examples 21-22), wherein the power providing means comprises a power supply unit (PSU), and wherein the power protection events comprise power limiting events initiated by the first component in response to a power output of the PSU exceeding a threshold power level.

Another example (e.g. example 24) relates to a previously-described example (e.g. one or more of examples 21-23), wherein the plurality of sampling periods are associated with an event-monitoring frequency, which are successive and time-adjacent to one another.

Another example (e.g. example 25) relates to a previously-described example (e.g. one or more of examples 21-24), wherein the plurality of sampling periods are associated with an event-monitoring frequency, which is based upon a number of power protection events occurring within a predetermined time period.

Another example (e.g. example 26) relates to a previously-described example (e.g. one or more of examples 21-25), wherein the instructions, when executed by the processing means, cause the electronic device to increase the monitoring frequency in response to the number of power protection events occurring over the predetermined time period exceeding a threshold event number.

Another example (e.g. example 27) relates to a previously-described example (e.g. one or more of examples 21-26), wherein the instructions, when executed by the processing means, cause the electronic device to increase the operational power limit of the first component and the second component in response to a number of power limiting events occurring within one of the plurality of sampling periods being less than or equal to a first threshold event number.

Another example (e.g. example 28) relates to a previously-described example (e.g. one or more of examples 21-27), wherein the instructions, when executed by the processing means, cause the electronic device to decrease the operational power limit of the first component and the second component in response to a number of power limiting events occurring within a further one of the plurality of sampling periods being greater than or equal to a second threshold event number that is different than the first threshold event number.

Another example (e.g. example 29) relates to a previously-described example (e.g. one or more of examples 21-28), wherein the instructions, when executed by the processing means, cause the electronic device to selectively adjust the operational power limit of the first component and the second component by: decreasing the operational power limit of the first component and the second component to a decreased operational power limit when a number of power limiting events occurring within a first one of the plurality of sampling periods exceeds a first threshold event number; and increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number.

Another example (e.g. example 30) relates to a previously-described example (e.g. one or more of examples 21-29), wherein the instructions, when executed by the processing means, cause the electronic device to adjust the operational power limit of the first component and the second component by adjusting a performance limit of the first component and/or the second component in accordance with one or more different time scales.

An example (e.g. example 31) is directed to an electronic device, comprising: a first component; a second component; storage means for storing instructions; and processing means for executing the instructions stored on the storage means to: determine a number of power protection events occurring within respective ones of a plurality of sampling periods, wherein the power protection events are associated with a power proving means that provides power to the first component and the second component; and selectively adjust, based upon an occurring frequency of the power protection events over the plurality of sampling periods, an operational power limit of the first component and the second component.

Another example (e.g. example 32), relates to a previously-described example (e.g. example 31), wherein the first component comprises a central processing unit (CPU), and wherein the second component comprises a dedicated graphics processing unit (GPU).

Another example (e.g. example 33) relates to a previously-described example (e.g. one or more of examples 31-32), wherein the power providing means comprises a power supply unit (PSU), and wherein the power protection events comprise power limiting events initiated by the first component in response to a power output of the PSU exceeding a threshold power level.

Another example (e.g. example 34) relates to a previously-described example (e.g. one or more of examples 31-33), wherein the plurality of sampling periods are associated with an event-monitoring frequency, which are successive and time-adjacent to one another.

Another example (e.g. example 35) relates to a previously-described example (e.g. one or more of examples 31-34), wherein the plurality of sampling periods are associated with an event-monitoring frequency, which is based upon a number of power protection events occurring within a predetermined time period.

Another example (e.g. example 36) relates to a previously-described example (e.g. one or more of examples 31-35), wherein the processing means executes the instructions to increase the monitoring frequency in response to the number of power protection events occurring over the predetermined time period exceeding a threshold event number.

Another example (e.g. example 37) relates to a previously-described example (e.g. one or more of examples 31-36), wherein the processing means executes the instructions to increase the operational power limit of the first component and the second component in response to a number of power limiting events occurring within one of the plurality of sampling periods being less than or equal to a first threshold event number.

Another example (e.g. example 38) relates to a previously-described example (e.g. one or more of examples 31-37), wherein the processing means executes the instructions to decrease the operational power limit of the first component and the second component in response to a number of power limiting events occurring within a further one of the plurality of sampling periods being greater than or equal to a second threshold event number that is different than the first threshold event number.

Another example (e.g. example 39) relates to a previously-described example (e.g. one or more of examples 31-38), wherein the processing means executes the instructions to selectively adjust the operational power limit of the first component and the second component by: decreasing the operational power limit of the first component and the second component to a decreased operational power limit when a number of power limiting events occurring within a first one of the plurality of sampling periods exceeds a first threshold event number; and increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number.

Another example (e.g. example 40) relates to a previously-described example (e.g. one or more of examples 31-39), wherein the processing means executes the instructions to adjust the operational power limit of the first component and the second component by adjusting a performance limit of the first component and/or the second component in accordance with one or more different time scales.

An apparatus as shown and described.

A method as shown and described.

### Conclusion

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

What is claimed is:

1. A non-transitory computer-readable medium having instructions stored thereon that, when executed by processing circuitry of an electronic device, cause the electronic device to:
determine a number of power protection events occurring within respective ones of a plurality of sampling periods,
wherein the power protection events are associated with a power source that provides power to a first component and a second component of the electronic device; and
selectively adjust, based upon an occurring frequency of the power protection events over the plurality of sampling periods, an operational power limit of the first component and the second component.

2. The non-transitory computer-readable medium of claim 1, wherein the first component comprises a central processing unit (CPU), and
wherein the second component comprises a dedicated graphics processing unit (GPU).

3. The non-transitory computer-readable medium of claim 1, wherein the power source comprises a power supply unit (PSU), and
wherein the power protection events comprise power limiting events initiated by the first component in response to a power output of the PSU exceeding a threshold power level.

4. The non-transitory computer-readable medium of claim 1, wherein the plurality of sampling periods are associated with an event-monitoring frequency, which are successive and time-adjacent to one another.

5. The non-transitory computer-readable medium of claim 1, wherein the plurality of sampling periods are associated with an event-monitoring frequency, which is based upon a number of power protection events occurring within a predetermined time period.

6. The non-transitory computer-readable medium of claim 5, wherein the instructions, when executed by the processing circuitry, cause the electronic device to increase the monitoring frequency in response to the number of power protection events occurring over the predetermined time period exceeding a threshold event number.

7. The non-transitory computer-readable medium of claim 1, wherein the instructions, when executed by the processing circuitry, cause the electronic device to increase the operational power limit of the first component and the second component in response to a number of power limiting events occurring within one of the plurality of sampling periods being less than or equal to a first threshold event number.

8. The non-transitory computer-readable medium of claim 7, wherein the instructions, when executed by the processing circuitry, cause the electronic device to decrease the operational power limit of the first component and the second component in response to a number of power limiting events occurring within a further one of the plurality of sampling periods being greater than or equal to a second threshold event number that is different than the first threshold event number.

9. The non-transitory computer-readable medium of claim 1, wherein the instructions, when executed by the processing circuitry, cause the electronic device to selectively adjust the operational power limit of the first component and the second component by:
decreasing the operational power limit of the first component and the second component to a decreased operational power limit when a number of power limiting events occurring within a first one of the plurality of sampling periods exceeds a first threshold event number; and
increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number.

10. The non-transitory computer-readable medium of claim 1, wherein the instructions, when executed by the processing circuitry, cause the electronic device to adjust the operational power limit of the first component and the second component by adjusting a performance limit of the first component and/or the second component in accordance with one or more different time scales.

11. An electronic device, comprising:
a first component;
a second component;
memory configured to store instructions; and
processing circuitry configured to execute the instructions stored on the memory to:
determine a number of power protection events occurring within respective ones of a plurality of sampling periods,
wherein the power protection events are associated with a power source that provides power to the first component and the second component; and
selectively adjust, based upon an occurring frequency of the power protection events over the plurality of sampling periods, an operational power limit of the first component and the second component.

12. The electronic device of claim 11, wherein the first component comprises a central processing unit (CPU), and
wherein the second component comprises a dedicated graphics processing unit (GPU).

13. The electronic device of claim 11, wherein the power source comprises a power supply unit (PSU), and
wherein the power protection events comprise power limiting events initiated by the first component in response to a power output of the PSU exceeding a threshold power level.

14. The electronic device of claim 11, wherein the plurality of sampling periods are associated with an event-monitoring frequency, which are successive and time-adjacent to one another.

15. The electronic device of claim 11, wherein the plurality of sampling periods are associated with an event-monitoring frequency, which is based upon a number of power protection events occurring within a predetermined time period.

16. The electronic device of claim 15, wherein the processing circuitry is configured to execute the instructions to increase the monitoring frequency in response to the number of power protection events occurring over the predetermined time period exceeding a threshold event number.

17. The electronic device of claim 11, wherein the processing circuitry is configured to execute the instructions to increase the operational power limit of the first component and the second component in response to a number of power limiting events occurring within one of the plurality of sampling periods being less than or equal to a first threshold event number.

18. The electronic device of claim 17, wherein the processing circuitry is configured to execute the instructions to decrease the operational power limit of the first component and the second component in response to a number of power limiting events occurring within a further one of the plurality of sampling periods being greater than or equal to a second threshold event number that is different than the first threshold event number.

19. The electronic device of claim 11, wherein the processing circuitry is configured to execute the instructions to selectively adjust the operational power limit of the first component and the second component by:
decreasing the operational power limit of the first component and the second component to a decreased operational power limit when a number of power limiting events occurring within a first one of the plurality of sampling periods exceeds a first threshold event number; and
increasing the operational power limit of the first component and the second component from the decreased operational power limit to an increased operational power limit when a number of power limiting events occurring within a second one of the plurality of sampling periods that is subsequent to the first one of the plurality of sampling periods is less than a second threshold event number.

20. The electronic device of claim 11, wherein the processing circuitry is configured to execute the instructions to adjust the operational power limit of the first component and the second component by adjusting a performance limit of the first component and/or the second component in accordance with one or more different time scales.
